(19) United States
(12) Patent Application Publication
(10) Pub. No.: US 2022/0140637 A1
(43) Pub. Date: May 5, 2022

(54) WIRELESS POWER TRANSMISSION SYSTEM, POWER TRANSMITTING DEVICE, POWER RECEIVING DEVICE, AND MOVABLE UNIT

(71) Applicant: PANASONIC INTELLECTUAL PROPERTY MANAGEMENT CO., LTD., Osaka (JP)

(72) Inventors: Hiroyuki HOSOI, Osaka (JP); Hiroshi YAMAMOTO, Osaka (JP)

(21) Appl. No.: 17/433,751

(22) PCT Filed: Feb. 26, 2020
(86) PCT No.: PCT/JP2020/007863

§ 371 Date: Aug. 25, 2021

(30) Foreign Application Priority Data
Feb. 28, 2019 (JP) 2019-036691

(51) Int. Cl. H02J 7/00; H02J 7/02; H02J 50/40; H02J 50/00

(52) U.S. Cl. CPC H02J 7/00712; H02J 7/0048; H02J 2207/20; H02J 50/402; H02J 50/005; H02J 7/02

(57) ABSTRACT

Power transmission is properly stopped before an electrical storage device becomes fully charged. A power transmitting device includes two transmission electrodes and a power transmitting circuit to supply AC power to the two transmission electrodes. The power receiving device includes: two reception electrodes being respectively opposed to the two transmission electrodes to receive the AC power from the two transmission electrodes; a power receiving circuit to convert the AC power received by the two reception electrodes into DC power and to output the DC power; a charge-discharge control circuit to control charging and discharging of the electrical storage device; and an impedance adjustment circuit to change an input impedance in accordance with a charge state of the electrical storage device as detected by the charge-discharge control circuit. In response to a change in at least one of voltage and current occurring due to a change in the input impedance during power transmission, the power transmitting circuit stops supply of the AC power.

### TECHNICAL FIELD

The present disclosure relates to a wireless power transmission system, a power transmitting device, a power receiving device, and a movable unit.

### BACKGROUND ART

In recent years, wireless power transmission techniques for wirelessly (contactlessly) transmitting electric power to devices that are capable of moving or being moved, e.g., mobile phones and electric vehicles, have been being developed. Wireless power transmission techniques include methods based on electromagnetic induction and methods based on electric field coupling. Among these, a wireless power transmission system based on the electric field coupling method is such that, while a pair of transmission electrodes and a pair of reception electrodes are opposed to each other, AC power is wirelessly transmitted from the pair of transmission electrodes to the pair of reception electrodes. A wireless power transmission system based on such an electric field coupling method may be used for the purpose of transmitting electric power to a load from a pair of transmission electrodes that are provided on the road surface (or on the floor surface). The load may be, for example, a motor or a battery in a movable unit such as a mobile robot. Patent Document 1 discloses an example of a wireless power transmission system based on such an electric field coupling method.

### CITATION LIST

### Patent Literature

[Patent Document 1] International Publication No. 2015/037526

### SUMMARY OF INVENTION

### Technical Problem

The present disclosure provides a wireless power transmission technique which makes it possible to properly stop power transmission before an electrical storage device becomes fully charged.

### Solution to Problem

A wireless power transmission system according to one implementation of the present disclosure includes a power transmitting device and a power receiving device. The power transmitting device includes two transmission electrodes and a power transmitting circuit to supply AC power to the two transmission electrodes. The power receiving device includes: two reception electrodes being respectively opposed to the two transmission electrodes to receive the AC power from the two transmission electrodes; a power receiving circuit to convert the AC power received by the two reception electrodes into DC power and to output the DC power; a charge-discharge control circuit being disposed between an electrical storage device to be charged by the DC power and the power receiving circuit to control charging and discharging of the electrical storage device; and an impedance adjustment circuit being disposed on a transmission path between the two reception electrodes and the electrical storage device to change an input impedance in accordance with a charge state of the electrical storage device as detected by the charge-discharge control circuit. In response to a change in at least one of voltage and current occurring due to a change in the input impedance during power transmission, the power transmitting circuit stops supply of the AC power.

General or specific aspects of the present disclosure may be implemented using a system, an apparatus, a method, an integrated circuit, a computer program, or a storage medium, or any combination of a system, an apparatus, a method, an integrated circuit, a computer program, and/or a storage medium.

### Advantageous Effects of Invention

The technique according to the present disclosure makes it possible to properly stop power transmission before an electrical storage device becomes fully charged.

### BRIEF DESCRIPTION OF DRAWINGS

FIG. 1 A diagram schematically showing an example of a wireless power transmission system based on an electric field coupling method.

FIG. 2 A diagram showing the general configuration of the wireless power transmission system.

FIG. 3 A diagram schematically showing another example of a wireless power transmission system according to the electric field coupling method.

FIG. 4 A diagram showing the general configuration of the wireless power transmission system shown in FIG. 3.

FIG. 5 A block diagram showing the configuration of a wireless power transmission system according to an illustrative embodiment of the present disclosure.

FIG. 6 A diagram showing a more specific exemplary configuration of a power transmitting circuit and a power receiving circuit.

FIG. 7A A diagram schematically showing an exemplary configuration of an inverter circuit.

FIG. 7B A diagram schematically showing an exemplary configuration of a rectifier circuit.

FIG. 8 A diagram showing an exemplary configuration of a charge-discharge control circuit and an impedance adjustment circuit.

FIG. 9 A diagram showing one example of the circuit configuration of a DC/DC converter.

FIG. 10A A diagram showing a switch device in which a switching element is connected in series with the circuit.

FIG. 10B A diagram showing a switch device in which a switching element is connected in parallel to the circuit.

FIG. 11 A diagram showing example waveforms of an output voltage Vsw and output current Ires of an inverter circuit.

FIG. 12 A diagram showing an exemplary configuration of a detector and a power transmission control circuit.

FIG. 13 A flowchart showing an exemplary operation of the charge-discharge control circuit.

FIG. 14 A flowchart showing an exemplary operation of the impedance adjustment circuit.

FIG. 15 A flowchart showing an exemplary operation of the power transmission control circuit.

FIG. 16 A flowchart showing a variation of the operation of the charge-discharge control circuit.

FIG. 17A A diagram showing an example where the impedance adjustment circuit is placed between reception electrodes and the power receiving circuit.

FIG. 17B A diagram showing an example where the impedance adjustment circuit is placed between a matching circuit and the rectifier circuit.

FIG. 17C A diagram showing an example where the impedance adjustment circuit is placed between the rectifier circuit and the charge-discharge control circuit.

FIG. 17D A diagram showing an example where the impedance adjustment circuit is placed between the charge-discharge control circuit and a battery.

FIG. 18A A diagram showing an example where transmission electrodes are installed on a lateral surface e.g., a wall.

FIG. 18B A diagram showing an example where the transmission electrodes are installed on a ceiling.

### DESCRIPTION OF EMBODIMENTS

(Findings Providing the Basis of the Present Disclosure)

Prior to describing embodiments of the present disclosure, findings providing the basis of the present disclosure will be described.

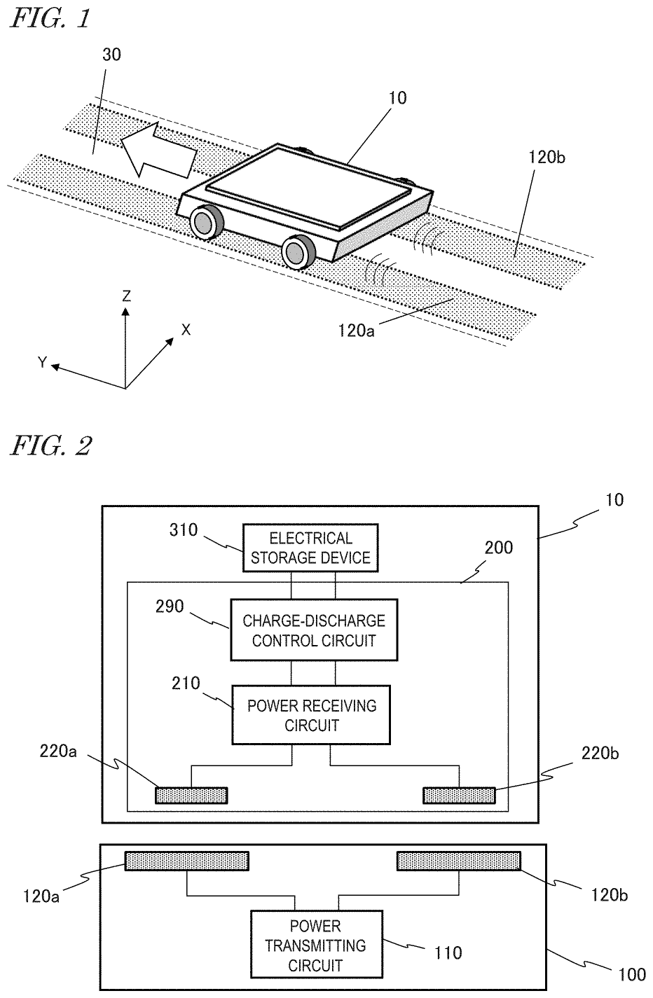

FIG. 1 is a diagram schematically showing an example of a wireless power transmission system based on the electric field coupling method under development by the inventors. The wireless power transmission system shown in the figure may be a system which wirelessly transmits electric power to a movable unit 10 that is used in transporting articles in a factory or a warehouse, for example. The movable unit 10 in this example is an automated guided vehicle (AGV). In this system, a pair of transmission electrodes 120a and 120b, which are in plate shape, are disposed on the floor surface 30. The pair of transmission electrodes 120a and 120b have a shape that is elongated in one direction. To the pair of transmission electrodes 120a and 120b, AC power is supplied from a power transmitting circuit not shown.

The movable unit 10 includes a pair of reception electrodes (not shown) opposing the pair of transmission electrodes 120a and 120b. With the pair of reception electrodes, the movable unit 10 receives AC power which has been transmitted from the transmission electrodes 120a and 120b. The received electric power is supplied to a load in the movable unit 10, e.g., a motor, a secondary battery, or a capacitor for electrical storage purposes. With this, the movable unit 10 may be driven or charged.

FIG. 1 shows XYZ coordinates indicating the X, Y and Z directions which are orthogonal to one another. The following description will rely on XYZ coordinates as shown in the figures. The direction that the transmission electrodes 120a and 120b extend will be referred to as the Y direction; a direction which is perpendicular to the surface of the transmission electrodes 120a and 120b as the Z direction; and a direction which is perpendicular to the Y direction and the Z direction as the X direction. Note that the orientation of any structure that is shown in a drawing of the present application is so set for ease of description, and it shall not limit the orientation in which an embodiment of the present disclosure may actually be employed. Moreover, the particular shape and size with which the whole or a part of any structure may be presented in a drawing shall not limit its actual shape and size.

FIG. 2 is a diagram showing the general configuration of the wireless power transmission system shown in FIG. 1. The wireless power transmission system includes a power transmitting device 100 and a movable unit 10. The power transmitting device 100 includes a pair of transmission electrodes 120a and 120b, and a power transmitting circuit 110 which supplies AC power to the transmission electrodes 120a and 120b. The power transmitting circuit 110 is, for example, an AC output circuit including an inverter circuit. The power transmitting circuit 110 converts DC power which is supplied from a power source not shown into AC power, and outputs it to the pair of transmission electrodes 120a and 120b. The movable unit 10 includes a power receiving device 200 and an electrical storage device 310. The power receiving device 200 includes a pair of reception electrodes 220a and 220b, a power receiving circuit 210, and a charge-discharge control circuit 290. The electrical storage device 310 is a device that stores electric power, e.g., a motor, a capacitor for electrical storage purposes, or a secondary battery. The power receiving circuit 210 converts the AC power received by the reception electrodes 220a and 220b into a voltage required by the electrical storage device 310, e.g., a DC voltage of a predetermined voltage level, and outputs it. The power receiving circuit 210 may include various circuits, e.g., a rectifier circuit and an impedance matching circuit. The charge-discharge control circuit 290 is a circuit that controls charging and discharging of the electrical storage device 310. Although not shown in FIG. 2, the movable unit 10 also includes other loads, such as electric motors for driving purposes. Through electric field coupling between the pair of transmission electrodes 120a and 120b and the pair of reception electrodes 220a and 220b, electric power is wirelessly transmitted while the two pairs are opposed to each other.

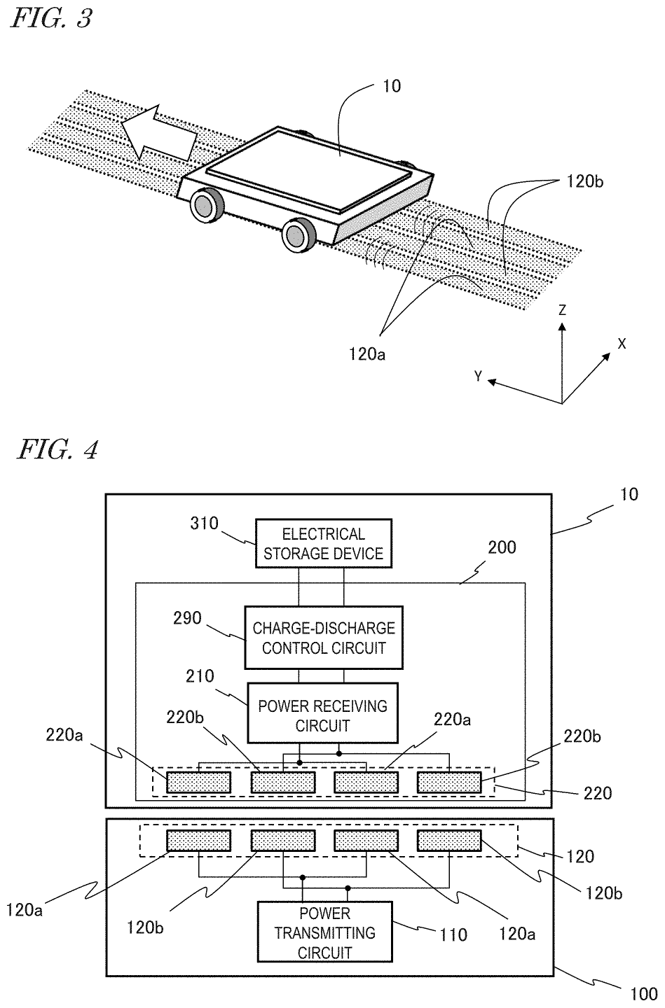

Each of the transmission electrodes 120a and 120b and the reception electrodes 220a and 220b may be split into two or more portions. For example, a configuration as shown in FIG. 3 and FIG. 4 may be adopted.

FIG. 3 and FIG. 4 are diagrams showing an example of a wireless power transmission system in which each of the transmission electrodes 120a and 120b and the reception electrodes 220a and 220b is split into two portions. In this example, the power transmitting device 100 includes two first transmission electrodes 120a and two second transmission electrodes 120b. The first transmission electrodes 120a and the second transmission electrodes 120b are arranged in an alternating manner. Similarly, the power receiving device 200 includes two first reception electrodes 220a and two second reception electrodes 220b. The two first reception electrodes 220a and the two second reception electrodes 220b are arranged in an alternating manner. During power transmission, the two first reception electrodes 220a are opposed to the two first transmission electrodes 120a, and the two second reception electrodes 220b are opposed to the two second transmission electrodes 120b. The power transmitting circuit 110 includes two terminals to output AC power. One terminal is connected to the two first transmission electrodes 120a, whereas the other terminal is connected to the two second transmission electrodes 120b. During power transmission, the power transmitting circuit 110 applies a first voltage to the two first transmission electrodes 120a, and applies a second voltage of an opposite phase to the first voltage to the two second transmission electrodes 120b. As a result of this, through electric field coupling between the transmission electrode group 120 including four transmission electrodes and the reception electrode group 220 including four reception electrodes, electric power is wirelessly transmitted. Such a configuration provides an effect of suppressing a leakage field at a boundary between any two adjacent transmission electrodes. Thus, in each of the power transmitting device 100 and the power receiving device 200, the number of electrodes with which to perform power transmission or power reception is not limited to two.

In the following embodiments, as shown in FIG. 1 and FIG. 2, a configuration in which the power transmitting device 100 includes two transmission electrodes and the power receiving device 200 includes two reception electrodes will be mainly described. In each of the following embodiments, each electrode may be split into multiple portions as illustrated in FIG. 3 and FIG. 4. In either case, an electrode(s) to which a first voltage is applied at a given moment and an electrode(s) to which a second voltage of an opposite phase to the first voltage is applied are arranged in an alternating manner. As used herein, an “opposite phase” is defined to encompass a phase difference which is anywhere in the range from 90 degrees to 270 degrees, without being limited to the case where the phase difference is 180 degrees. In the following description, a plurality of transmission electrodes included in the power transmitting device 100 may be non-discriminately referred to as “transmission electrodes 120” and a plurality of reception electrodes included in the power receiving device 200 may be non-discriminately referred to as “reception electrodes 220”.

With such a wireless power transmission system, the movable unit 10 is able to wirelessly receive electric power while moving along the transmission electrodes 120. While the transmission electrodes 120 and the reception electrodes 220 remain in a closely opposed state, the movable unit 10 is able to move along the transmission electrodes 120. As a result, the movable unit 10 is able to move while charging the electrical storage device 310, e.g., a battery or a capacitor.

In such a wireless power transmission system, during a charge operation, when the electrical storage device 310 mounted in the movable unit 10 becomes fully charged, it is necessary to immediately stop the charge operation in order to prevent overcharging. When it becomes fully charged, the charge-discharge control circuit 290 may turn off an internal switch, for example, to stop supplying of power to the electrical storage device 310. In order to suppress damage to the circuitry, the power transmitting device 100 is required to immediately stop power transmission. In order to realize this operation, for example, an approach may be introduced such that, before reaching a full charge, a notification is sent from the power receiving device 200 to the power transmitting device 100 via wireless communication or the like, upon which the power transmitting device 100 stops power transmission.

However, it has been found that a method utilizing wireless communication to send a notification from the power receiving device 200 to the power transmitting device 100 may require time for such communication, and therefore cannot immediately stop power transmission. In a system where rapid charging during travel is required, a very large electric power may be transmitted in order to complete the required charging within several seconds, for example. In the case where communication is utilized for the stopping of power transmission, a delay of e.g. several milliseconds to several seconds may occur. If a communication delay occurs and the stopping of power transmission is lagged, the circuitry may be damaged. If the power-receiving side goes into an unloaded state due to stopping of charging, the transmission characteristics may considerably fluctuate, whereby an overvoltage or an overcurrent may occur. As a result of this, circuit elements in the power transmitting device 100 and the power receiving device 200 may break down.

Patent Document 1 discloses a method in which the voltage across an electrode on the power-transmitting side is monitored, and if the absolute value of an amount of change in the voltage per predetermined period exceeds a threshold value, the power transmission is stopped. However, this method does not address the aforementioned problems. In this method, the power receiving device stops charging and only then the power transmitting device detects the same; therefore, an overvoltage or an overcurrent may occur before the stopping of power transmission. Furthermore, in this method, a high voltage on the order of several kV may be applied to the transmission electrode(s), making it impossible to employ generic devices for the purpose of monitoring.

Based on the above thoughts, the inventors have sought for a new wireless power transmission system to solve the aforementioned problems. As a result, the inventors have arrived at an approach in which, before a full charge is reached, the power receiving device changes the input impedance, and the power transmitting device detects this change, thereby being able to solve the above problems. Hereinafter, the embodiments of the present disclosure will be described in outline.

A wireless power transmission system according to one implementation of the present disclosure includes a power transmitting device and a power receiving device. The power transmitting device includes two transmission electrodes and a power transmitting circuit to supply AC power to the two transmission electrodes. The power receiving device includes: two reception electrodes being respectively opposed to the two transmission electrodes to receive the AC power from the two transmission electrodes; a power receiving circuit to convert the AC power received by the two reception electrodes into DC power and to output the DC power; a charge-discharge control circuit being disposed between an electrical storage device to be charged by the DC power and the power receiving circuit to control charging and discharging of the electrical storage device; and an impedance adjustment circuit being disposed on a transmission path between the two reception electrodes and the electrical storage device. The impedance adjustment circuit changes an input impedance in accordance with a charge state of the electrical storage device as detected by the charge-discharge control circuit. In response to a change in at least one of voltage and current occurring due to a change in the input impedance during power transmission, the power transmitting circuit stops supply of the AC power.

With the above configuration, the impedance adjustment circuit changes the input impedance in accordance with a charge state of the electrical storage device as detected by the charge-discharge control circuit. Then, the power transmitting circuit stops supply of the AC power in response to a change in at least one of voltage and current occurring due to a change in the input impedance during power transmission. Herein, the “input impedance” means an impedance of the power receiving device as viewed from the power transmitting device.

With the above configuration, before the electrical storage device becomes fully charged, power transmission can be stopped. As a result, an overvoltage or an overcurrent can be prevented from occurring before power transmission is stopped, thus reducing the risk of break-downs of circuit elements.

The power transmitting circuit may include an inverter circuit to output the AC power. The power transmitting circuit may be configured to cause the inverter circuit to stop in response to a change in an output voltage and an output current from the inverter circuit occurring due to a change in the input impedance during power transmission. For example, the power transmitting circuit may be configured to cause the inverter circuit to stop in response to a change in a phase difference between the output voltage and the output current occurring due to a change in the input impedance during power transmission.

With the above configuration, during power transmission, the power transmitting circuit monitors a phase difference between the output voltage and the output current of the inverter circuit. Based on the value of this phase difference, a change in the input impedance of the impedance adjustment circuit can be detected with a higher accuracy.

The impedance adjustment circuit may be configured to change the input impedance when an amount of stored electricity in the electrical storage device reaches a predetermined threshold value. The amount of stored electricity can be expressed as, for example, a state of charge (SOC), i.e., a ratio of the present remaining capacity and the fully charged capacity, or a percentage representation thereof. The amount of stored electricity may be estimated, for example, from an integral of a voltage (meaning an effective value of voltage; hereinafter the same holds true) that is applied to the electrical storage device or a current that flows into the electrical storage device. Therefore, the impedance adjustment circuit may change the input impedance when an integrated value of the voltage or current of the electrical storage device has reached a predetermined threshold value.

The impedance adjustment circuit may set the input impedance to three or more different values in accordance with charge states of the electrical storage device. For example, the impedance adjustment circuit may set the input impedance to a first value when the amount of stored electricity in the electrical storage device reaches a first threshold value, and set the input impedance to a second value which is different from the first value when the amount of stored electricity reaches a second threshold value which is greater than the first threshold value. For example, when the state of charge of the electrical storage device has reached 50%, the input impedance may be changed to the first value, and when it has reached 90%, the input impedance may be changed to the second value. Introducing such multiple levels of impedance changes allows for a more flexible control of power transmission.

After changing the input impedance and after a predetermined time has elapsed, the impedance adjustment circuit may set the input impedance back to a value of the input impedance before the change. By thus changing the input impedance with a predetermined pattern, an impedance change due to an abnormality can be distinguished from an impedance change that has been intentionally made by the impedance adjustment circuit.

The amount of change in the input impedance made by the impedance adjustment circuit may be set to such an amount that the change in the wireless power transmission characteristics will not be excessive, for example. By doing so, and by further reverting to the original impedance in a predetermined time, damage to the circuitry can be suppressed, and impedance changes due to abnormalities can be clearly distinguished.

The power transmitting circuit, the power receiving circuit may include a rectifier circuit to convert the AC power received by the two reception electrodes into DC power. The impedance adjustment circuit may include a DC/DC converter circuit disposed between the rectifier circuit and the electrical storage device. The impedance adjustment circuit can change the input impedance by varying an ON time ratio of a switching element included in the DC/DC converter circuit. Use of a DC/DC converter circuit makes it easy to finely change the input impedance, or change the input impedance in multiple levels.

The present disclosure encompasses a power transmitting device and a power receiving device for use in the aforementioned wireless power transmission system. Each of the power transmitting device and the power receiving device may be manufactured or sold by itself alone.

The present disclosure also encompasses a movable unit that includes the aforementioned power receiving device. The movable unit includes the power receiving device, an electrical storage device, and an electric motor(s) for driving purposes. The movable unit is not limited to a vehicle such as the aforementioned AGV, but encompasses any movable object that is driven by electric power. Examples of movable units may include an electric vehicle that includes an electric motor and one or more wheels. Such a vehicle may be the aforementioned AGV, an electric vehicle (EV), or an electric cart, for example. The “movable unit” within the meaning of the present disclosure also encompasses any movable object that lacks wheels. For example, bipedal robots, unmanned aerial vehicles (UAV, or so-called drones) such as multicopters, and manned electric aircraft are also encompassed within “movable units”.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar constituent elements are denoted by identical reference numerals.

### Embodiments

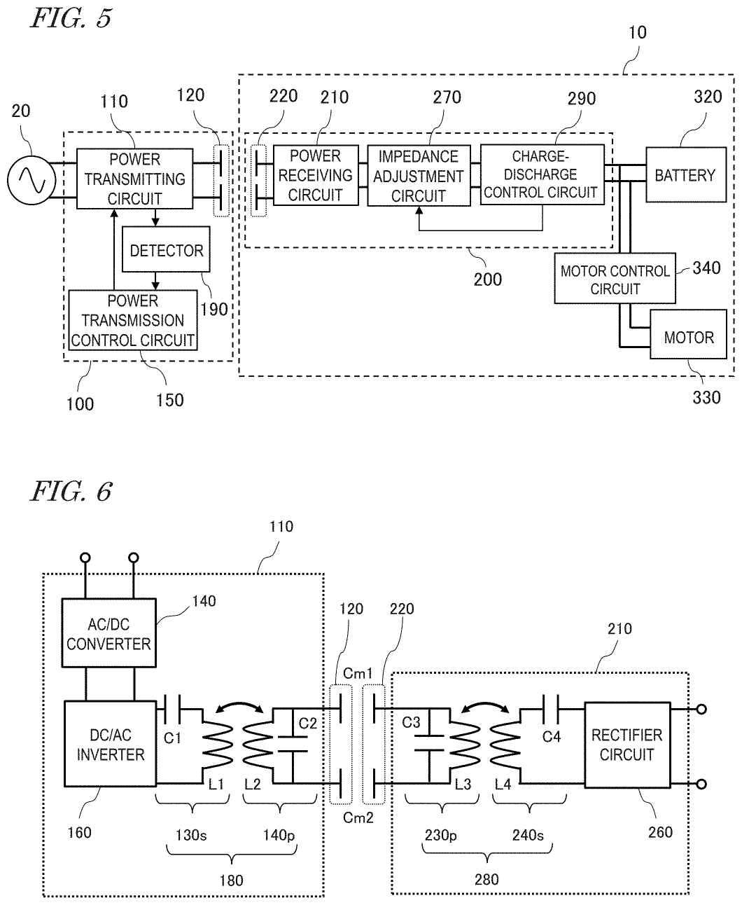

FIG. 5 is a block diagram showing the configuration of a wireless power transmission system according to an illustrative embodiment of the present disclosure. The wireless power transmission system includes a power transmitting device 100 and a movable unit 10. The movable unit 10 includes a power receiving device 200, a secondary battery 320 which is an electrical storage device, an electric motor 330 for driving purposes, and a motor control circuit 340. FIG. 5 also shows a power source 20, which is an external element to the wireless power transmission system. Hereinafter, the secondary battery 320 may simply be referred to as the “battery 320”, and the electric motor 330 for driving purposes may simply be referred to as the “motor 330”.

The power transmitting device 100 includes two transmission electrodes 120 and a power transmitting circuit 110 to supply AC power to the two transmission electrodes 120. The power transmitting device 100 shown in FIG. 3 further includes a detector 190 and a power transmission control circuit 150. The detector 190 detects a voltage and current in the power transmitting circuit 110. Based on an output from the detector 190, the power transmission control circuit 150 controls the power transmitting circuit 110.

The power receiving device 200 includes two reception electrodes 220, a power receiving circuit 210, an impedance adjustment circuit 270, and a charge-discharge control circuit 290. While respectively being opposed to the two transmission electrodes 120, the two reception electrodes 220 receive AC power from the transmission electrodes 120 through electric field coupling. The power receiving circuit 210 converts the AC power received by the reception electrodes 220 into DC power, and outputs it. The charge-discharge control circuit 290 monitors the charge state of the secondary battery 320, and controls charging and discharging. The charge-discharge control circuit 290 is also referred to as a battery management unit (BMU). The charge-discharge control circuit 290 also has the function of protecting cells in the secondary battery 320 from overcharging, overdischarging, overcurrent, high temperature, low temperature, or other states. The impedance adjustment circuit 270 is connected between the power receiving circuit 210 and the charge-discharge control circuit 290. The impedance adjustment circuit 270 changes the input impedance in accordance with a charge state of the battery 320 as detected by the charge-discharge control circuit 290.

The power transmitting circuit 110 stops supply of AC power in response to a change in voltage and current occurring due to a change in the input impedance of the impedance adjustment circuit 270 during power transmission. This operation is controlled by the power transmission control circuit 150.

Hereinafter, the respective component elements will be described more specifically.

The power source 20 may be an AC power source for commercial use, for example. The power source 20 outputs an AC power with a voltage of 100 V and a frequency of 50 Hz or 60 Hz, for example. The power transmitting circuit 110 converts the AC power supplied from the power source 20 into an AC power of a higher voltage and a higher frequency, and supplies it to the pair of transmission electrodes 120.

The secondary battery 320 is a rechargeable battery, such as a lithium-ion battery or a nickel-metal hydride battery. The movable unit 10 is able to move by driving the motor 330 with the electric power stored in the secondary battery 320. Instead of the secondary battery 320, a capacitor for electrical storage purposes may be used. For example, a high-capacitance and low-resistance capacitor, such as an electric double layer capacitor or a lithium-ion capacitor, may be used.

When the movable unit 10 moves, the amount of stored electricity in the secondary battery 320 becomes lower. Therefore, recharging will be required in order to continue moving. Therefore, when the amount of stored electricity becomes smaller than a predetermined threshold value during movement, the movable unit 10 moves to the power transmitting device 100 to perform charging.

The motor 330 may be any type of motor, such as a permanent magnet synchronous motor, an induction motor, a stepping motor, a reluctance motor, or a DC motor. The motor 330 rotates wheels of the movable unit 10 via a transmission mechanism, e.g., shafts and gears, thus causing the movable unit 10 to move.

The motor control circuit 340 controls the motor 330 to cause the movable unit 10 to perform a desired operation. The motor control circuit 340 may include various circuits, such as an inverter circuit, that are designed in accordance with the type of the motor 330.

Although not particularly limited, the respective sizes of the housing of the movable unit 10 according to the present embodiment, the transmission electrodes 120, and the reception electrodes 220 may be set to the following sizes, for example. The length (i.e., the size along the Y direction) of each transmission electrode 120 may be set in a range from 50 cm to 20 m, for example. The width (i.e., the size along the X direction) of each transmission electrode 120 may be set in a range from 5 cm to 2 m, for example. The sizes along the traveling direction and the lateral direction of the housing of the movable unit 10 may be set in a range from 20 cm to 5 m, for example. The length of each reception electrode 220 may be set in a range from 5 cm to 2 m, for example. The width of each reception electrode 220a may be set in a range from 2 cm to 2 m, for example. The gap between two transmission electrodes, and the gap between two reception electrodes, may be set to a range from 1 mm to 40 cm, for example. However, these numerical ranges are not limiting.

FIG. 6 is a diagram showing a more specific exemplary configuration of the power transmitting circuit 110 and the power receiving circuit 210. The power transmitting circuit 110 includes an AC/DC converter circuit 140, a DC/AC inverter circuit 160, and a matching circuit 180. In the following description, the AC/DC converter circuit 140 may simply be referred to as the “converter 140”, and the DC/AC inverter circuit 160 may simply be referred to as the “inverter 160”.

The converter 140 is connected to the AC power source 20. The converter 140 converts the AC power which is output from the AC power source 20 into DC power, and outputs it. The inverter 160, which is connected to the converter 140, converts the DC power which is output from the converter 140 into an AC power of a relatively high frequency, and outputs it. The matching circuit 180, which is connected between the inverter 160 and the transmission electrodes 120, matches the inverter 160 and the transmission electrodes 120 in impedance. The transmission electrodes 120 send the AC power which is output from the matching circuit 180 out into space. Through electric field coupling, the reception electrodes 220 receive at least a portion of the AC power which is sent out from the transmission electrodes 120. A matching circuit 280, which is connected between the reception electrodes 220 and a rectifier circuit 260, matches the reception electrodes 220 and the rectifier circuit 260 in impedance. The rectifier circuit 260 converts the AC power which is output from the matching circuit 280 into DC power, and outputs it. The DC power which is output from the rectifier circuit 260 is sent to the impedance adjustment circuit 270.

In the example shown in the figure, the matching circuit 180 of the power transmitting device 100 includes a series resonant circuit 130a which is connected to the inverter 160, and a parallel resonant circuit 140p which is connected to the transmission electrodes 120 and establishes inductive coupling with the series resonant circuit 130s. The series resonant circuit 130s of the power transmitter 100 includes a first coil L1 and a first capacitor C1 being connected in series. The parallel resonant circuit 140p of the power transmitter 100 includes a second coil L2 and a second capacitor C2 being connected in parallel. The first coil L1 and the second coil L2 constitute a transformer whose coupling is based on a predetermined coupling coefficient. The turns ratio between the first coil L1 and the second coil L2 is set to a value that realizes a desired step-up ratio. The matching circuit 180 steps up a voltage on the order of several ten to several hundred v which is output from the inverter 160 to a voltage on the order of several kV, for example.

The matching circuit 280 of the power receiving device 200 includes a parallel resonant circuit 230p which is connected to the reception electrodes 220 and a series resonant circuit 240s which is connected to the rectifier circuit 260 and establishes inductive coupling with the parallel resonant circuit 230p. The parallel resonant circuit 230p includes a third coil L3 and a third capacitor C3 being connected in parallel. The series resonant circuit 240s of the power receiving device 200 includes a fourth coil L4 and a fourth capacitor C4 being connected in series. The third coil L3 and the fourth coil L4 constitute a transformer whose coupling is based on a predetermined coupling coefficient. The turns ratio between the third coil L3 and the fourth coil L4 is set to a value that realizes a desired step-down ratio. The matching circuit 280 steps down a voltage on the order of several kV which is received by the reception electrodes 220 to a voltage on the order of several ten to several hundred v, for example.

Each coil in the resonant circuits 130s, 140p, 230p and 240s may be a planar coil or a laminated coil formed on a circuit board, or a wound coil in which a copper wire, a litz wire, a twisted wire or the like is used, for example. For each capacitor in the resonant circuits 130s, 140p, 230p and 240s, any type of capacitor having a chip shape or a lead shape can be used, for example. A capacitance between two wiring lines with air interposed between them may be allowed to function as each capacitor. The self-resonance characteristics that each coil possesses may be utilized in the place of any such capacitor.

The resonant frequency f0 of the resonant circuits 130s, 140p, 230p and 240s is typically set to be equal to the transmission frequency f1 during power transmission. It is not necessary for the resonant frequency f0 of each of the resonant circuits 130s, 140p, 230p and 240s to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example.

In the present embodiment, what exists between the transmission electrodes 120 and the reception electrodes 220 is an air gap, with a relatively long distance therebetween (e.g., about 10 mm). Therefore, the capacitances Cm1 and Cm2 between the electrodes are very small, and impedances of the transmission electrodes 120 and the reception electrodes 220 are very high (e.g., on the order of several kA). On the other hand, the impedances of the inverter 160 and the rectifier circuit 260 are as low as about several Q. In the present embodiment, the parallel resonant circuits 140p and 230p are disposed so as to be closer to, respectively, the transmission electrodes 120 and the reception electrodes 220; and the series resonant circuits 130s and 240s are disposed closer to, respectively, the inverter 160 and the rectifier circuit 260. Such configuration facilitates impedance matching. A series resonant circuit has zero (0) impedance during resonance, and therefore is suitable for matching with a low impedance. On the other hand, a parallel resonant circuit has an infinitely large impedance during resonance, and therefore is suitable for matching with a high impedance. Thus, as in the configuration shown in FIG. 6, disposing a series resonant circuit on the circuit with low impedance and disposing a parallel resonant circuit on the electrode with high impedance facilitates impedance matching.

Note that, in configurations where the distance between the transmission electrodes 120 and the reception electrodes 220 is shortened, or a dielectric is disposed therebetween, the electrode impedance will be so low that an asymmetric resonant circuit configuration is not needed. In the absence of impedance matching issues, one or both of the matching circuits 180 and 280 may be omitted. In the case of omitting the matching circuit 180, the inverter 160 and the transmission electrodes 120 are directly connected. In the case of omitting the matching circuit 280, the rectifier circuit 260 and the reception electrodes 220 are directly connected. In the present specification, a configuration where the matching circuit 180 is provided also qualifies as a configuration in which the inverter 160 and the transmission electrodes 120 are connected. Similarly, a configuration where the matching circuit 280 is provided also qualifies as a configuration in which the rectifier circuit 260 and the reception electrodes 220 are connected.

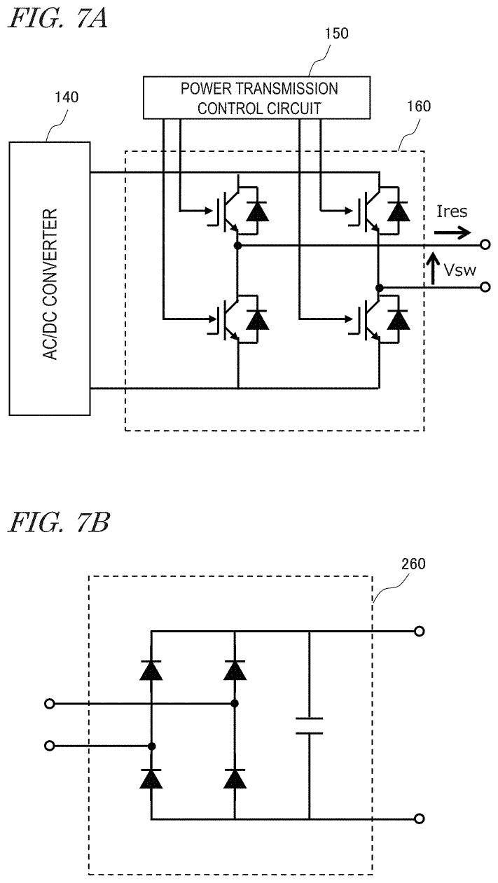

FIG. 7A is a diagram schematically showing an exemplary configuration for the inverter 160. In this example, the inverter 160 is a full-bridge inverter circuit that includes four switching elements and the power transmission control circuit 150. Each switching element may be a transistor switch such as an IGBT or a MOSFET. The power transmission control circuit 150 includes a gate driver which outputs a control signal to control the ON (conducting) or OFF (non-conducting) state of each switching element and a microcontroller unit (MCU) which causes the gate driver to output a control signal. Instead of the full-bridge inverter that is shown in the figure, a half-bridge inverter, or any other oscillation circuit, e.g., that of class E, may also be used.

As shown in FIG. 7A, the current and voltage output from the inverter 160 are denoted as Ires and Vsw, respectively. The current Ires and voltage Vsw are detected by the detector 190 shown in FIG. 5. While a power transmission operation is being carried out, the detector 190 monitors the current Ires and voltage Vsw.

FIG. 7B is a diagram schematically showing an exemplary configuration for the rectifier circuit 260. In this example, the rectifier circuit 260 is a full-wave rectifier circuit including a diode bridge and a smoothing capacitor. The rectifier circuit 260 may have any other rectifier configuration. The rectifier circuit 260 converts the received AC energy into DC energy which is available for use by the load, such as the battery 320.

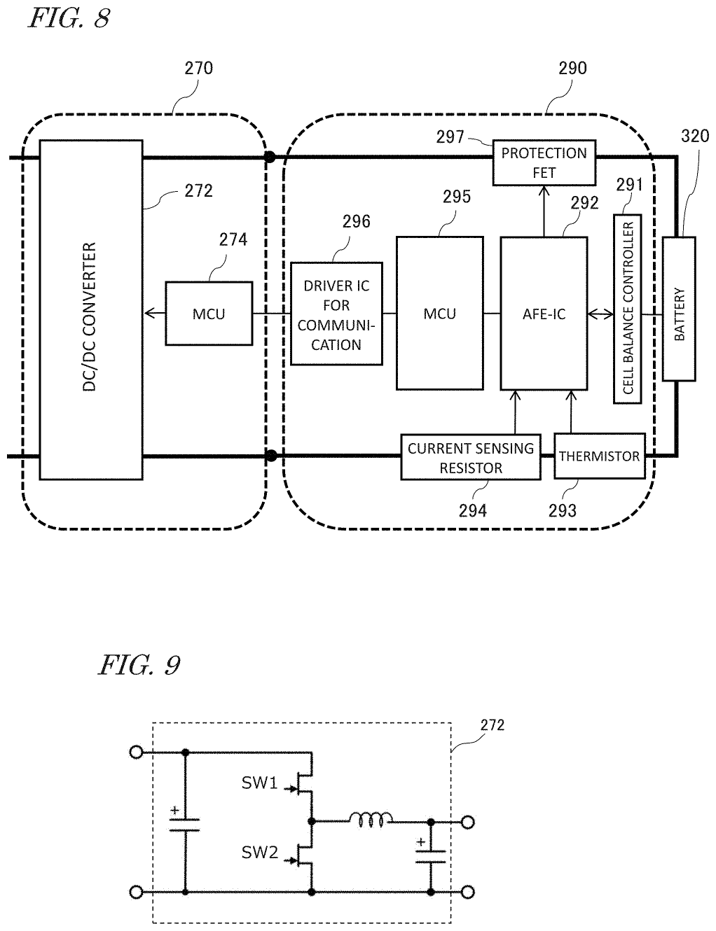

FIG. 8 is a diagram showing an exemplary configuration for the charge-discharge control circuit 290 and the impedance adjustment circuit 270. The charge-discharge control circuit 290 in this example includes a cell balance controller 291, an analog front-end IC (AFE-IC) 292, a thermistor 293, a current sensing resistor 294, an MCU 295, a driver IC 296 for communication purposes, and a protection FET 297. The cell balance controller 291 is a circuit which, for the secondary battery 320 including multiple cells, equalizes the stored electric energies in the respective cells. The AFE-IC 292 is a circuit which controls the cell balance controller 291 and the protection FET 297 based on a cell temperature measured by the thermistor 293 and a current detected by the current sensing resistor 294. The MCU 295 is a circuit which controls communications with other circuits via the driver IC 296 for communication purposes.

The impedance adjustment circuit 270 in this example includes a DC/DC converter circuit 272 and an MCU 274. Hereinafter, the DC/DC converter circuit 272 will simply be referred to as “DC/DC converter 272”. The MCU 274 is a circuit which controls the DC/DC converter 272. By varying the ON time ratios of the switching elements included in the DC/DC converter 272, the MCU 274 changes the impedance of the DC/DC converter 272. As used herein, the detect “ON time ratio” refers to a length of time that is set to ON during each period, i.e., a duty ratio. By controlling ON/OFF of the switching elements, the input impedance of the impedance adjustment circuit 270 as viewed from the power-transmitting side can be changed, whereby the state of power transmission of the system is changed.

FIG. 9 is a diagram showing one example of the circuit configuration of the DC/DC converter 272. The DC/DC converter 272 in this example is a step-down converter (buck converter) that includes two switches SW1 and SW2, two capacitors, and a reactor. Through duty control of the HIGH-side switch SW1, it is possible to finely adjust the input impedance. Impedance adjustments are possible within a range where the transmission state does not significantly fluctuate, and therefore circuit break downs due to fluctuations in the transmission state can be prevented.

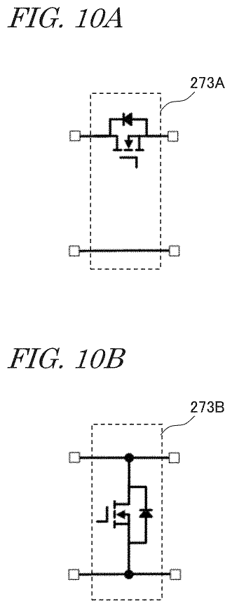

Instead of the DC/DC converter 272, a configuration shown in FIG. 10A or FIG. 10B may be adopted. FIG. 10A shows a switch device 273A in which a switching element is connected in series with the circuit. FIG. 10B shows a switch device 273B in which a switching element is connected in parallel to the circuit. With such configurations, too, through ON/OFF control of the switching element, it is possible to switch between the two states of being short-circuited and being open, thereby changing the input impedance. Despite a disadvantage in that the transmission state is likely to significantly fluctuate, the configurations of FIG. 10A and FIG. 10B provide an advantage of enabling impedance adjustments with a simpler configuration.

When the impedance adjustment circuit 270 changes the input impedance, the states of current and voltage within the power transmitting circuit 110 change. Based on such changes, the power transmitting device 100 is able to detect a change in the input impedance. For example, when the HIGH-side switch SW1 shown in FIG. 9 transitions from ON to OFF, thus taking an open state, the state of wireless power transmission changes so that the phase difference associated with the output voltage and output current of the inverter 160 in the power transmitting circuit 110 changes. Specifically, a phase difference of 90° (where the active power equals the reactive power) exists in an open state. By using the step-down DC/DC converter 272 as shown in FIG. 9 to finely adjust the impedance, it is possible to freely vary the phase difference within a range of 90° or less.

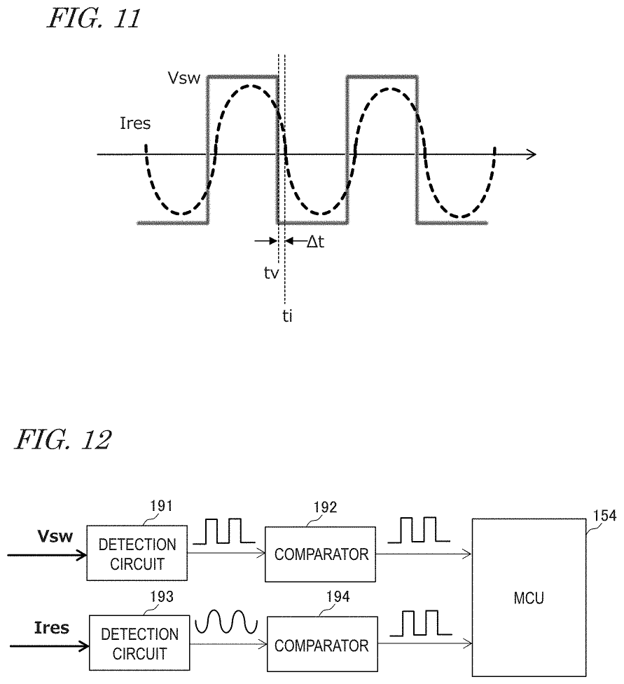

FIG. 11 is a diagram showing example waveforms of the output voltage Vsw and output current Ires of the inverter 160 in the power transmitting circuit 110. As the impedance adjustment circuit 270 changes impedance, as shown in FIG. 11, a difference Δt between the voltage inversion timing tv and current inversion timing ti changes. By calculating this time difference Δt (i.e., phase difference) per predetermined period, the power transmission control circuit 150 is able to detect a change in the input impedance.

FIG. 12 is a diagram showing an exemplary configuration of the detector 190 and the power transmission control circuit 150. The detector 190 in this example includes: a detection circuit 191 that detects the output voltage Vsw and converts it to a voltage signal, which is a small signal; a comparator 192 for voltage phase detection purposes; a detection circuit 193 that detects the output current Ires and converts it to a voltage signal, which is a small signal; and a comparator 194 for current phase detection purposes. The power transmission control circuit 150 includes an MCU 154. With voltage divider resistors, the comparator 192 converts the output voltage Vsw from the inverter 160 into AC pulses of a small signal, and outputs them while switching between High and Low with the signal inversion timings. As a result, voltage pulses of small-amplitude are output. The comparator 194 detects the positive or negative polarity of the current waveform which is output from the detection circuit 193, and outputs this as current pulses of small-amplitude, with the negative state being the High state. The voltage pulses and the current pulses are input to the MCU 154. The MCU 154 detects edges of voltage pulses output from the comparator 192 and current pulses output from the comparator 194, thereby detecting their respective phases. Then, it calculates a phase difference between them. If the phase difference is within a predetermined range, it issues a gate block command. With the gate block command, each switching element in the inverter 160 is turned OFF, so that power transmission is stopped. After power transmission is stopped, if an instruction to restart power transmission is received, the MCU 154 may issue a restart signal. Note that the aforementioned detection method for phase differences is one example. For example, if the output current Ires is small, a differential amplification circuit may be used to amplify the output current Ires before being input to the comparator 194.

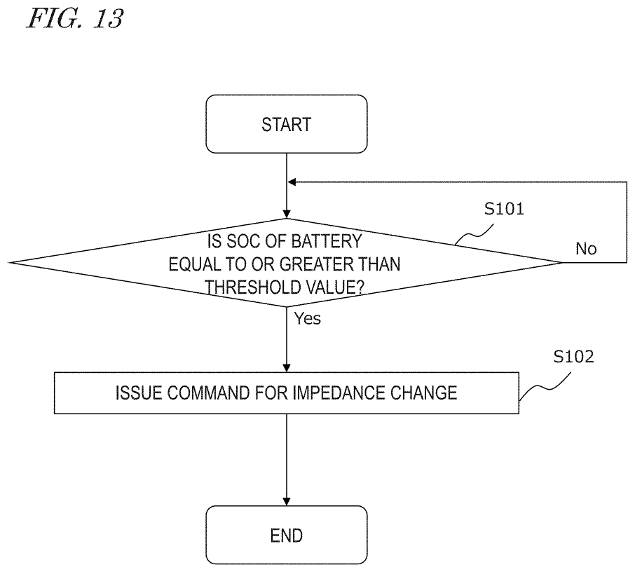

Next, with reference to FIG. 13 to FIG. 15, an exemplary operation according to the present embodiment where power transmission is stopped before full charge will be described.

FIG. 13 is a flowchart showing an exemplary operation of the charge-discharge control circuit 290. The charge-discharge control circuit 290 in this example constantly monitors the state of charge (SOC) of the battery 320 during charging. At predetermined time intervals, the charge-discharge control circuit 290 determines whether or not the SOC is equal to or greater than a threshold value (step S101). The threshold value may be set to a value that is slightly smaller than 100%, for example. If the SOC is equal to or greater than the threshold value, the charge-discharge control circuit 290 issues to the impedance adjustment circuit 270 a command that impedance should be changed (step S102). Issuance of the command may be made by, for example, the MCU 295 shown in FIG. 8 sending it to the MCU 274 of the impedance adjustment circuit 270 via the driver IC 296 for communication purposes.

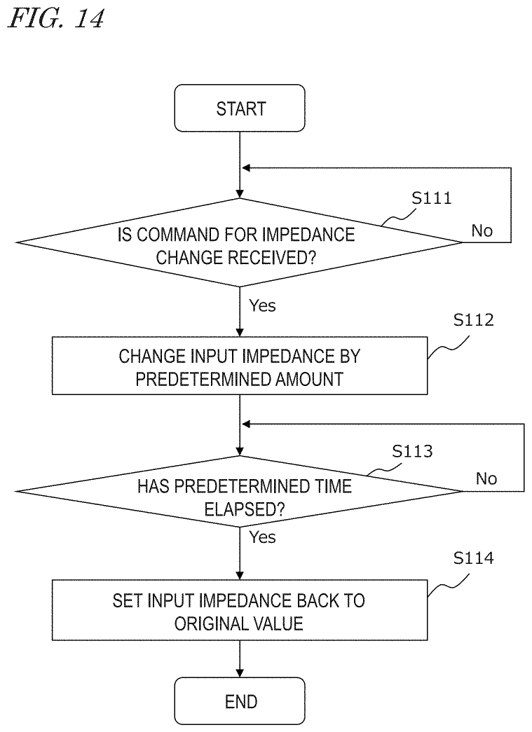

FIG. 14 is a flowchart showing an exemplary operation of the impedance adjustment circuit 270. During the operation, the impedance adjustment circuit 270 in this example determines whether a command for impedance change has been received or not (step S111). If it is determined Yes, the impedance adjustment circuit 270 changes the input impedance by a predetermined amount (step S112). This operation may be performed by, for example, the MCU 274 shown in FIG. 8 varying the ON time ratio of a switching element (e.g., the HIGH-side switch SW1 in FIG. 9) in the DC/DC converter 272 by a certain amount. Although the amount of impedance change may be set to any arbitrary value, it may be set so that the rate of change from its value before the change is less than 200% in the direction of increasing the input impedance, for example. By setting the amount of impedance change to such a relatively small value, it is ensured that the change in the power transmission characteristics will not be excessive. Next, the impedance adjustment circuit 270 maintains this impedance state until a predetermined time elapses (step S113). After the predetermined time has elapsed, the impedance adjustment circuit 270 sets the input impedance back to the original value (step S114).

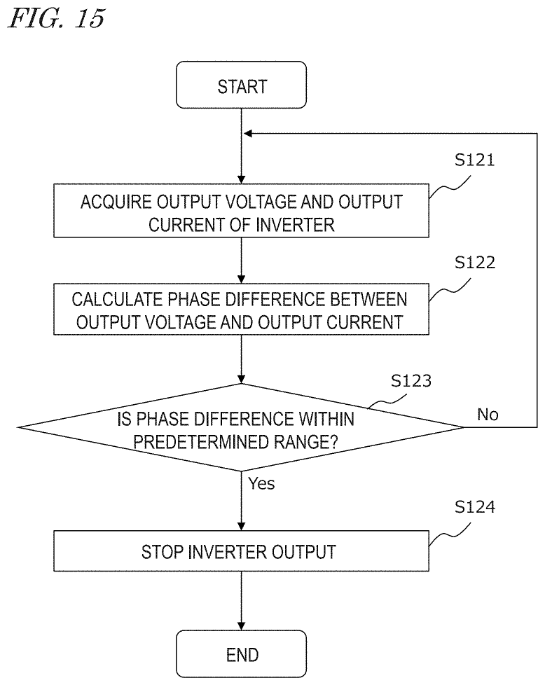

FIG. 15 is a flowchart showing an exemplary operation of the power transmission control circuit 150 of the power transmitting device 100. During operation, the power transmission control circuit 150 in this example acquires an output voltage and output current of the inverter 160 from the detector 190 at every predetermined time (step S121). Next, the power transmission control circuit 150 calculates a phase difference between the acquired output voltage and output current (step S122). The phase difference may be obtained by the method described with reference to FIG. 11 and FIG. 12, for example. Then, the power transmission control circuit 150 determines whether the phase difference is within a predetermined range or not (step S123). If it is determined No, control returns to step S121. If it is determined Yes, the power transmission control circuit 150 causes the inverter 160 to stop outputting (step S124).

Through the above operation, before the battery 320 becomes fully charged, power transmission can be promptly stopped. With the method according to the present embodiment, once the charge-discharge control circuit 290 decides to change impedance, the power transmission control circuit 150 is able to detect an impedance change and stop power transmission, in a short period of time on the order of e.g. several microseconds. This can greatly reduce the risk of allowing transmission a large electric power to continue after stopping of charging to result in a break-down of circuit elements.

Furthermore, as in the example of FIG. 14, by previously setting an amount of change in input impedance and a duration of change, an impedance change that has been caused by an abnormality can be easily distinguished from an impedance change serving as a notification of a charge state. Damage to circuitry can be minimized by setting the amount of change in input impedance and the duration of change at such values that the change in the power transmission characteristics will not be excessive.

In the present embodiment, the power transmitting circuit 110 causes the inverter 160 to stop in response to a change in the phase difference between the output voltage and the output current of the inverter 160. However, this operation is not limiting. For example, an impedance change may be detected based on at least one of the output voltage and the output current of the inverter 160. However, with the above-described method based on a change in the phase difference, misdetections can be reduced as compared to any method that detects impedance changes based on the output voltage alone or the output current alone.

The impedance adjustment circuit 270 may set the input impedance to three or more different values, in accordance with the charge states of the battery 320. Hereinafter, one example of such operation will be described.

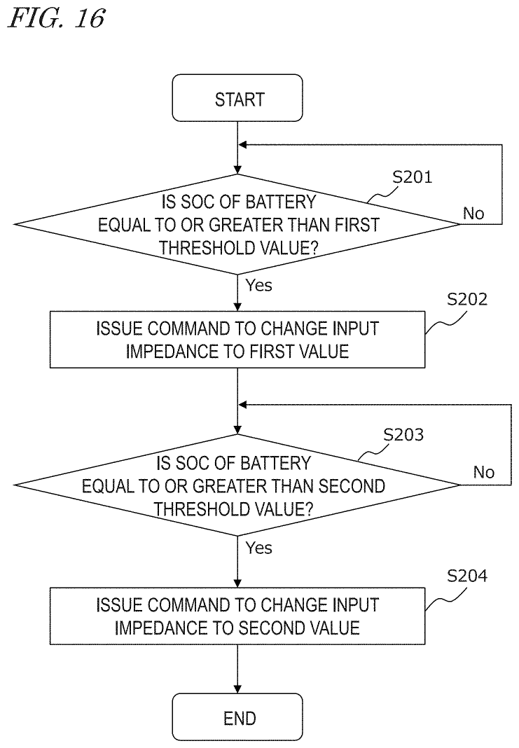

FIG. 16 is a flowchart showing a variation of the operation of the charge-discharge control circuit 290. Instead of the operation shown in FIG. 13, the charge-discharge control circuit 290 may perform the operation shown in FIG. 16. In the example of FIG. 16, after beginning charging, the charge-discharge control circuit 290 monitors the charge state of the battery 320, and determines whether the SOC is equal to or greater than a first threshold value at every predetermined period (step S201). The first threshold value may be a value that is considerably smaller than 100%, e.g. 50%. If it is determined Yes at step S201, the charge-discharge control circuit 290 issues a command to the impedance adjustment circuit 270 that the input impedance should be changed to a first value (step S202). Upon receiving this command, the impedance adjustment circuit 270 changes the input impedance to the first value. Although the first value may be set to any arbitrary value, for example, it may be set so that the rate of change from its value before the change in the input impedance is less than 200% in the direction of increasing the input impedance. By setting it to such a relatively small rate of change, the damage to circuit elements caused by abrupt fluctuations in the transmission characteristics can be reduced. Next, the charge-discharge control circuit 290 again monitors the charge state of the battery 320, and determines whether the SOC is equal to or greater than a second threshold value at every predetermined period (step S203). The second threshold value is set to a value that is greater than the first threshold value. The second threshold value may be set to a value near full-charge, e.g. 90%. If it is determined Yes at step S203, the charge-discharge control circuit 290 issues a command to the input impedance adjustment circuit 270 that the input impedance should be changed to a second value (step S204). Upon receiving this command, the impedance adjustment circuit 270 changes the input impedance to the second value. The second value may be set to any value different from the first value. In order to avoid drastic fluctuations in the transmission characteristics, the second value may also be set so that the rate of change from its value before the change in the input impedance is less than 300% in the direction of increasing the input impedance, for example.

In the example of FIG. 16, when the SOC of the battery 320 reaches the first threshold value, the impedance adjustment circuit 270 sets the input impedance to the first value, which is different from the initial value. By detecting this change, the power transmission control circuit 150 is able to detect that the SOC has reached the first threshold value. Furthermore, when the SOC has reached the second threshold value, which is greater than the first threshold value, the impedance adjustment circuit 270 sets the input impedance to the second value, which is different first from the value. By detecting this change, the power transmission control circuit 150 is able to detect that the SOC has reached the second threshold value. According to this example, the power transmitting circuit 110 is able to grasp the charge state of the battery 320 in two levels, during power transmission. This enables a more flexible control of power transmission.

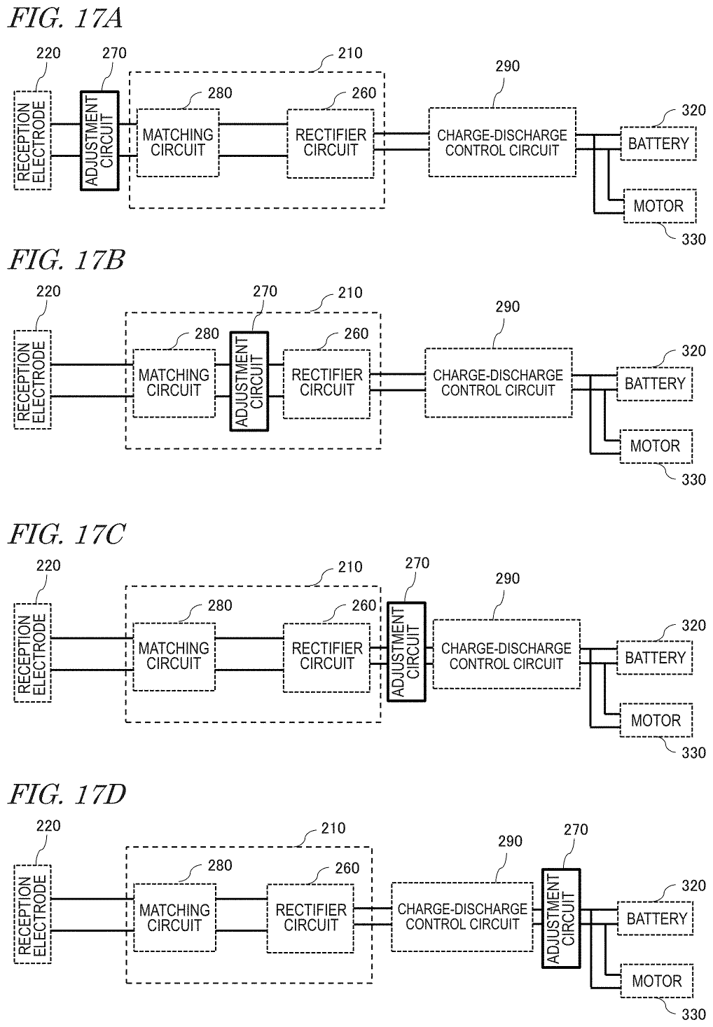

FIG. 17A to FIG. 17D are diagrams showing variations concerning the positioning of the impedance adjustment circuit 270. FIG. 17A shows an example where the impedance adjustment circuit 270 is placed between the reception electrodes 220 and the power receiving circuit 210. FIG. 17B shows an example where the impedance adjustment circuit 270 is placed between the matching circuit 280 and the rectifier circuit 260 in the power receiving circuit 210. FIG. 17C shows an example where the impedance adjustment circuit 270 is placed between the rectifier circuit 260 in the power receiving circuit 210 and the charge-discharge control circuit 290. FIG. 17D shows an example where the impedance adjustment circuit 270 is placed between the charge-discharge control circuit 290 and the battery 320. Thus, the impedance adjustment circuit 270 may be placed at any arbitrary position on the transmission path between the two reception electrodes and the battery 320. However, adopting the positioning of FIG. 17C as in the foregoing embodiments provides the following advantages.
Since it suffices to adjust the impedance at a position where a relatively low DC voltage is applied, the configuration and control of the impedance adjustment circuit 270 can be simplified.
Impedance can be adjusted without affecting the control of charging by the charge-discharge control circuit 290.

Although the pair of transmission electrodes 120 are installed on the ground in the above embodiments, the pair of transmission electrodes 120 may instead be installed on a lateral surface, e.g., a wall, or an overhead surface, e.g., a ceiling. Depending on the place and orientation in which the transmission electrodes 120 are installed, the arrangement and orientation of the reception electrodes 220 of the movable unit 10 are to be determined.

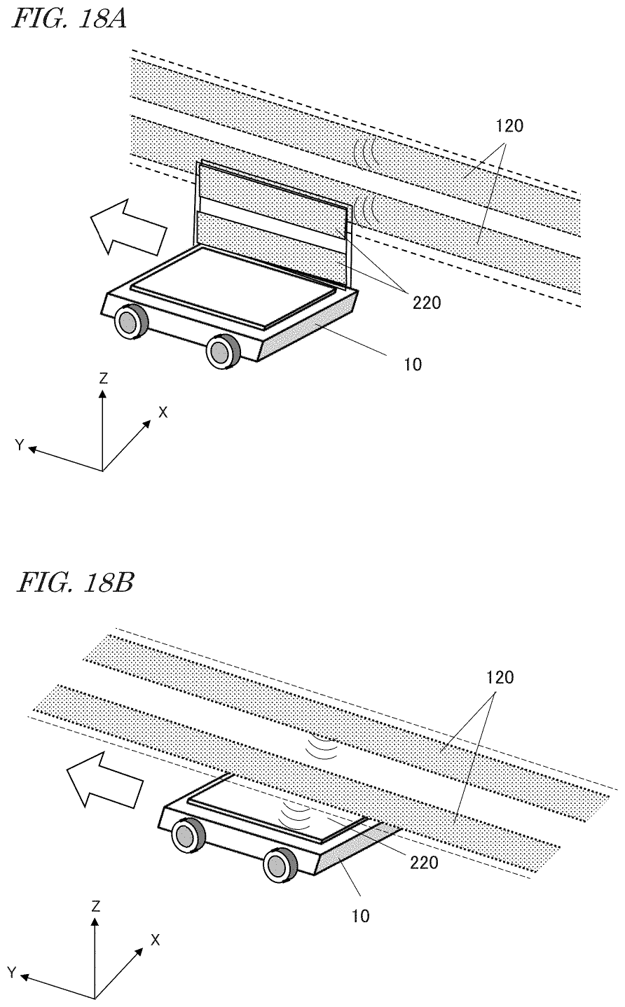

FIG. 18A shows an example where the transmission electrodes 120 are installed on a lateral surface e.g., a wall. In this example, the reception electrodes 220 are provided on a lateral side of the movable unit 10. FIG. 18B shows an example where the transmission electrodes 120 are installed on a ceiling. In this example, the reception electrodes 220 are provided on the top of the movable unit 10. As demonstrated by these examples, there may be a variety of arrangements for the transmission electrodes 120 and the reception electrodes 220.

A wireless power transmission system according to an embodiment of the present disclosure may be used as a system of transportation for articles within a factory, as mentioned above. The movable unit 10 functions as a cart having a bed on which to carry articles, and autonomously move in the factory to transport articles to necessary places. However, without being limited to such purposes, the wireless power transmission system and the movable unit according to the present disclosure are also usable for various other purposes. For example, without being limited to an AGV, the movable unit may be any other industrial machine, a service robot, an electric vehicle, a multicopter (drone), or the like. Without being limited to being used in a factory, the wireless power transmission system may be used in shops, hospitals, households, roads, runways, or other places, for example.

### INDUSTRIAL APPLICABILITY

The technique according to the present disclosure is applicable to any device that is driven with electric power. For example, it is suitably applicable to electric vehicles, such as automated guided vehicles (AGV).

### REFERENCE SIGNS LIST

10 movable unit
20 power source
30 floor surface
100 power transmitting device
110 power transmitting circuit
120, 120a, 120b transmission electrode
140 AC/DC converter circuit
150 power transmission control circuit
160 inverter circuit
180 matching circuit
180s series resonant circuit
180p parallel resonant circuit
190 detector
200 power receiving device
210 power receiving circuit
220, 220a, 220b reception electrode
250 power reception control circuit
260 rectifier circuit
270 impedance adjustment circuit
272 DC/DC converter circuit
280 matching circuit
280p parallel resonant circuit
280a series resonant circuit
290 charge-discharge control circuit
320 secondary battery
330 electric motor
340 motor control circuit

1. A wireless power transmission system comprising:
a power transmitting device; and
a power receiving device, wherein,
the power transmitting device includes
two transmission electrodes and
a power transmitting circuit to supply AC power to the two transmission electrodes;
the power receiving device includes
two reception electrodes being respectively opposed to the two transmission electrodes to receive the AC power from the two transmission electrodes,
a power receiving circuit to convert the AC power received by the two reception electrodes into DC power and to output the DC power,
a charge-discharge control circuit being disposed between an electrical storage device to be charged by the DC power and the power receiving circuit to control charging and discharging of the electrical storage device, and
an impedance adjustment circuit being disposed on a transmission path between the two reception electrodes and the electrical storage device to change an input impedance in accordance with a charge state of the electrical storage device as detected by the charge-discharge control circuit; and,
in response to a change in at least one of voltage and current occurring due to a change in the input impedance during power transmission, the power transmitting circuit stops supply of the AC power.

2. The wireless power transmission system of claim 1, wherein the power transmitting circuit includes an inverter circuit to output the AC power, and causes the inverter circuit to stop in response to a change in an output voltage and an output current from the inverter circuit occurring due to a change in the input impedance during power transmission.

3. The wireless power transmission system of claim 2, wherein the power transmitting circuit causes the inverter circuit to stop in response to a change in a phase difference between the output voltage and the output current occurring due to a change in the input impedance during power transmission.

4. The wireless power transmission system of claim 1, wherein the impedance adjustment circuit changes the input impedance when an amount of stored electricity in the electrical storage device reaches a predetermined threshold value.

5. The wireless power transmission system of claim 1, wherein the impedance adjustment circuit sets the input impedance to three or more different values in accordance with charge states of the electrical storage device.

6. The wireless power transmission system of claim 5, wherein the impedance adjustment circuit sets the input impedance to a first value when the amount of stored electricity in the electrical storage device reaches a first threshold value, and sets the input impedance to a second value which is different from the first value when the amount of stored electricity reaches a second threshold value which is greater than the first threshold value.

7. The wireless power transmission system of claim 1, wherein, after changing the input impedance and after a predetermined time has elapsed, the impedance adjustment circuit sets the input impedance back to a value of the input impedance before the change.

8. The wireless power transmission system of claim 1, wherein,
the power receiving circuit includes a rectifier circuit to convert the AC power received by the two reception electrodes into DC power; and
the impedance adjustment circuit includes a DC/DC converter circuit disposed between the rectifier circuit and the electrical storage device, and changes the input impedance by varying an ON time ratio of a switching element included in the DC/DC converter circuit.

9. The power transmitting device in the wireless power transmission system of claim 1.

10. The power receiving device in the wireless power transmission system of claim 1.

11. A movable unit comprising:
the power receiving device of claim 10;
the electrical storage device; and
an electric motor for driving purposes.
